(19) United States
(12) Patent Application Publication
(10) Pub. No.: US 2016/0111018 A1
(43) Pub. Date: Apr. 21, 2016

(54) METHOD AND SYSTEM FOR FACILITATING LEARNING OF A PROGRAMMING LANGUAGE

(71) Applicant: Rian Douglas Sousa, Wayland, MA (US)

(72) Inventor: Rian Douglas Sousa, Wayland, MA (US)

(21) Appl. No.: 14/869,044

(22) Filed: Sep. 29, 2015

Related U.S. Application Data
(60) Provisional application No. 62/066,745, filed on Oct. 21, 2014.

(51) Int. Cl. G09B 19/00; G06F 3/0481; G09B 5/02; G06F 9/45

(52) U.S. Cl. CPC G09B 19/0053; G06F 8/42; G06F 3/0481; G09B 5/02

(57) ABSTRACT

A computer implemented method of and system for facilitating learning of a programming language are disclosed. The method includes presenting content corresponding to a concept. Subsequently, an exemplary-code corresponding to the concept may be presented. The exemplary-code may be based on the programming language. Further, a learning user-interface configured for receiving a user-code from the learner may be presented. Furthermore, an exemplary-output based on the exemplary-code may be presented. Additionally, a user-output based on the user-code may also be presented. In some embodiments, a practicing user-interface including each of a workspace region and a resources region may also be presented.

### CROSS REFERENCE TO RELATED APPLICATIONS

The present application claims benefit of U.S. Provisional Patent Application No. 62/066,745, filed Oct. 21, 2014, entitled “Online Lesson Delivery & Learning Platform”, the disclosure of which is incorporated herein by reference in its entirety.

### FIELD

The disclosure generally relates to education. More specifically, the disclosure relates to method and system for facilitating learning of a programming language.

### BACKGROUND

With the widespread use of computers, there is an increasing demand for programmers who can develop software applications to solve real world problems. These programmers are required to be proficient in one or more programming languages in order to develop reliable software applications.

Existing techniques of teaching and learning programming languages are limited in their effectiveness. For instance, learners are generally presented with complex user-interface with several features that may be confusing. Particularly, in cases where the learners are in the age group of 8 to 16 years of age, existing techniques of learning programming languages are not learner-friendly.

Accordingly, there is a need for improved methods and systems of facilitating learning of programming languages.

### SUMMARY

Disclosed is a computer implemented method of facilitating learning of a programming language. The method includes presenting content corresponding to a concept. Subsequently, an exemplary-code corresponding to the concept may be presented. The exemplary-code may be based on the programming language. Further, a learning user-interface configured for receiving a user-code from the learner may be presented. Furthermore, an exemplary-output based on the exemplary-code may be presented. Additionally, a user-output based on the user-code may also be presented. In some embodiments, a practicing user-interface including each of a workspace region and a resources region may also be presented.

Also disclosed is a system for facilitating learning of a programming language. The system includes a processor configured for executing program instructions and a computer readable medium configured for storing the program instructions. Executing the program instructions may cause presenting content corresponding to a concept. Further, executing the program instructions may cause presenting of an exemplary-code corresponding to the concept. The exemplary-code may be based on the programming language. Furthermore, executing the program instructions may cause presenting a learning user-interface configured for receiving a user-code from the learner. Additionally, executing the program instructions may cause presenting an exemplary-output based on the exemplary-code. The exemplary-output may be a representation of a result of executing the exemplary-code. Further, executing the program instructions may cause presenting a user-output based on the user-code. The user-output may be a representation of a result of executing the user-code.

### BRIEF DESCRIPTION OF DRAWINGS

FIG. 1 illustrates a method of facilitating learning of a programming language in accordance with an embodiment.

FIG. 2 illustrates a method of facilitating learning of a programming language in accordance with another embodiment.

FIG. 3 illustrates a method of facilitating learning of a programming language in accordance with yet another embodiment.

FIG. 4 illustrates a system for facilitating learning of a programming language in accordance with an embodiment.

FIG. 5 illustrates a virtual flashcard for facilitating learning of a programming language in accordance with an embodiment.

FIG. 6 illustrates a learning user-interface for facilitating learning of a programming language in accordance with an embodiment.

FIG. 7 illustrates a feedback provided to a learner for facilitating learning of a programming language in accordance with an embodiment.

FIG. 8 illustrates display of exemplary-output and user-output for facilitating learning of a programming language in accordance with an embodiment.

FIG. 9 illustrates a practicing user-interface for facilitating learning of a programming language in accordance with an embodiment.

### DETAILED DESCRIPTION

The following detailed description is provided with reference to the figures. Exemplary, and in some case preferred, embodiments are described to illustrate the disclosure, not to limit its scope, which is defined by the claims. Those of ordinary skill in the art will recognize a number of equivalent variations in the description that follows.

Disclosed is a computer implemented method of facilitating learning of a programming language. The term “computer implemented method” is to be understood to mean a method that may be performed at least in part by a computer. The programming language may in general be a language in which instructions are provided by a user to a computer in order to perform an operation. In an instance, the instructions may correspond to specific steps of an algorithm. In an embodiment, the programming language may be based on textual form. For example, alphanumeric tokens may be used to express the instructions. In another embodiment, the programming language may be based on pictograms. For example, predefined pictograms may be used to express the instructions. Examples of the programming language include, but are not limited to, Java, Python, C, C++, C#, objective-C, Ruby, SQL, JavaScript, PHP, CSS and HTML.

Learning of the programming language may involve one or more of understanding of the primitives of the programming language, syntax to be followed while expressing an instruction using the primitives and a style guide to be followed while writing a program. For example, learning a programming language such as Python may include gaining an understanding of mathematical operators such as, ‘+’, ‘−’, ‘=’, ‘*’, ‘**’, ‘/’ and ‘//’ etc. and built-in functions such as ‘list( )’, ‘set( )’, ‘dict( )’ etc. Further, learning Python may also include gaining knowledge of the reserved words that may not be used as variable names. Furthermore, learning Python may include understanding of rules such as “enclosing string constants with either single quotes or double quotes while assigning values to a string variable”. Similarly, learning Python may include gaining knowledge of style guidelines such as “limiting the number of characters on a line of the source code to 79”.

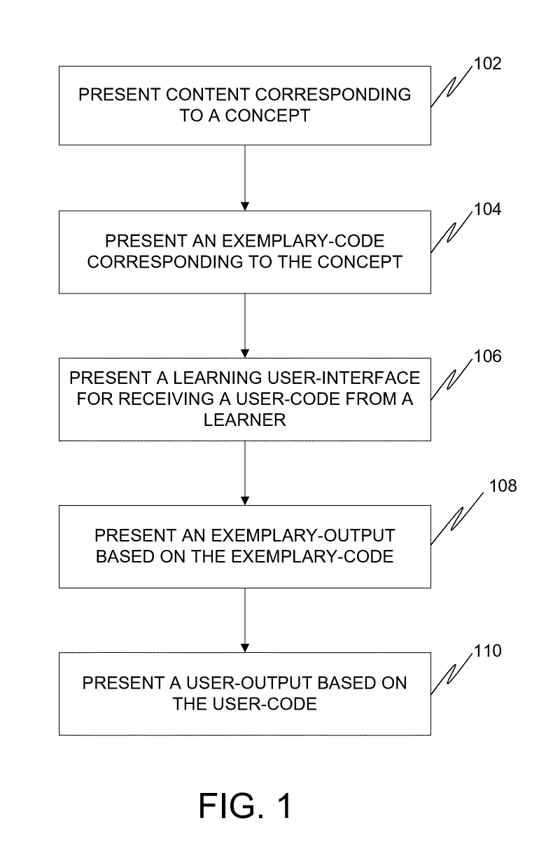

FIG. 1 illustrates a computer implemented method of facilitating learning of the programming language. As shown, at step 102, content corresponding to a concept may be presented to a learner. In an instance, the concept may be an aspect of the programming language. For example, the concept may be ‘integer variables”. Accordingly, content corresponding to the concept may include rules to be followed while creating integer variables such as, for example, limitations on names used for integer variables. In another instance, the concept may be an aspect of an algorithm which may be implemented using the programming language. For example, the concept may be “binary sorting”. Accordingly, content corresponding to the concept may include a sequence of steps associated with the “binary sorting” algorithm.

In an embodiment, the concept may be determined based on a selection performed by the learner. For example, the learner may be provided with a user-interface configured for displaying a collection of concepts and accepting a selection of the concept. In another embodiment, the concept may be determined based on a selection performed by an instructor. For example, the instructor may be provided with a user-interface configured for displaying a collection of concepts and accepting a selection of the concept. Further, the concept may be determined based on a pedagogical technique used for facilitating learning of the programming language. For example, the pedagogical technique may be “Project based learning”. Accordingly, based on a project elected by either the learner or the instructor, the concept may be determined. For instance, the project may include one or more lessons. Further, a lesson of the one or more lessons may include a task. Furthermore, in order to successfully perform the task, the learner may be required to learn the concept. Furthermore, one or more of the one or more lessons and one or more tasks may be ordered in a sequence. For instance, the one or more lessons may be ordered in a sequence based on corresponding difficulty levels. In another instance, the one or more lessons may be ordered in a sequence based on dependencies amongst the one or more lessons. For example, a first lesson of the one or more lessons may precede a second lesson of the one or more lessons if understanding the first lesson is required for understanding the second lesson. Further, the concept may be identified based on the sequence. For instance, the concept may be identified based on a position of the task or the lesson in the sequence. Accordingly, the concept may be associated with a difficulty level corresponding to the position of the task or the lesson in the sequence.

In an embodiment, presenting content corresponding to the concept may include displaying the content. For example, the content may include textual description of the concept such as, a definition of the concept. Accordingly, the definition may be displayed to the learner on a display device such as an LCD screen of a laptop computer. In another embodiment, presenting content may include playing a media file containing the content. For example, the content may include a multimedia presentation describing the concept. Accordingly, the multimedia presentation may be played on a media player including a display device and speakers. In an instance, the media player may be a computer such as, for example, a desktop computer, a laptop computer, a tablet computer and a smart phone. In yet another embodiment, presenting the content may include providing the content through a touch modality. For example, the content may be presented on a Braille display. In a further embodiment, presenting the content corresponding to the concept may include simultaneously providing the content over multiple modalities such as, for example, visual modality, aural modality and a touch modality.

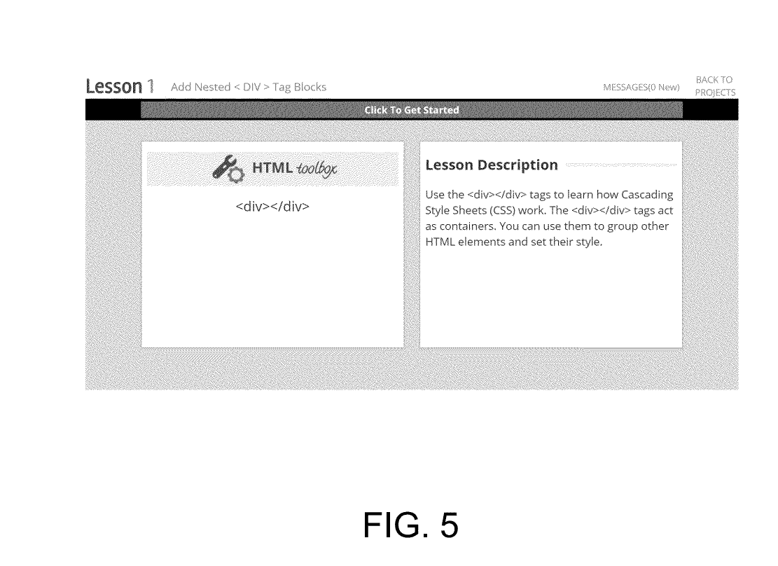

In an embodiment, presenting the content corresponding to the concept may include displaying a virtual flashcard. The virtual flashcard is a learning aid including a visual representation of the content corresponding to the concept. For instance, the virtual flashcard may include visual representation of the name of the concept along with a brief description of the concept as exemplarily illustrated in FIG. 5. Further, the virtual flashcard may be displayed once or more than once in order to increase effectiveness of learning. In general, the virtual flashcard may contain the content in a form that facilitates memorization of the content corresponding to the concept. For example, in an embodiment, a front side of the virtual flashcard may include the name of the concept and the back side of the virtual flashcard may include a brief description of the concept. Further, in an instance, the front side of the virtual flashcard may be displayed to the user. Subsequent to receiving an input, such as a touch input, from the learner, the virtual flashcard may be flipped to show the back side for a predetermined amount of time. Thereafter, the front side of the virtual flashcard may be displayed again.

In an embodiment, content corresponding to the concept may be presented in the form of an audio concurrent with the displaying of the virtual flashcard. In one instance, the content corresponding to the concept displayed in the virtual flashcard may be different from the content corresponding to the concept presented in the form of audio. In another instance, the content corresponding to the concept displayed in the virtual flashcard may be identical to the content corresponding to the concept presented in the form of audio.

Subsequent to presenting the content corresponding to the concept, an exemplary-code corresponding to the concept may be presented to the learner at step 104. Further, the exemplary-code may be based on the programming language. In an instance, the exemplary-code may embody the concept in the programming language. Moreover, in an instance, the exemplary-code may be a code-snippet embodying the concept. In another instance, the exemplary-code may be a complete program that may be executed meaningfully. For example, if the concept is ‘div’ tags in HTML, the exemplary-code may be a source code for a webpage using the ‘div’ tags such that the execution of the exemplary-code may result in display of the webpage.

At step 106, a learning user-interface may be presented for receiving a user-code from the learner. In an instance, the user-code may be code entered by the learner based on the exemplary-code. In an instance, the learner may be required to enter the user-code similar to the exemplary-code. For example, a structure of the user-code may be similar to a structure of the exemplary-code. However, they may be a difference between the exemplary-code and the user-code. As an example, consider the exemplary-code to be HTML code configured for displaying text message of a certain format such as bold and having the colour blue. Accordingly, the user-code to be entered by the learner may be HTML code configured for displaying another text message with a different format such as italics and having the colour red. In another instance, the learner may be required to enter the user-code that may be substantially different from the exemplary-code. However, each of the exemplary-code and the user-code may embody the concept. For example, consider the exemplary-code to be a Python script for performing an operation such as squaring of each integer in a list using list comprehension. Accordingly, the user-code to be entered by the learner may be a Python script for performing a different operation on each integer in the list using list comprehension. In general, the user-code and the exemplary-code may be related such that the learner may enter the user-code by inferring one or more of a syntactical construction and a logical construction from the exemplary-code.

In an embodiment, the learning user-interface may be a graphical user-interface such as a text input area configured for accepting textual input while concurrently displaying the textual input. In another embodiment, the learning user-interface may include a code template. For example, the learning user-interface may be a graphical user-interface such as a text input area configured for displaying the code template.

In an instance, the code template may be based on the exemplary-code. Accordingly, some portions of the code template may be identical to the corresponding portions in the exemplary-code. For example, if the exemplary-code is a HTML code for displaying a text message in a format such as bold and having a font of “Arial”, the code template may include HTML code with HTML tags corresponding to the text message and the formatting. However, the code template may not include the text message. In this particular case, the learner may be required to enter the user-code within the code template by inputting a different text message between the HTML tags corresponding to the text message. In another instance, the learner may be required to modify the HTML tags to change the formatting of the text message. In general, the code template may be of a form such that an effort required by the learner to enter the user-code may be reduced in comparison to case where the code template is not present. For example, the code template may include source code at least a part of which may be structurally similar to the exemplary-code but may not include some portions such as variable values as present in the exemplary-code. Accordingly, the learner may be required to enter the variable values in the code template in order to create the user-code. In an embodiment, a portion of the code template may be highlighted. Accordingly, the learner may enter or modify source code corresponding to the portion that is highlighted. In another embodiment, a portion of the exemplary-code may be highlighted. Accordingly, the learner may be required to enter or modify source code in the code template corresponding to the portion of the exemplary-code that is highlighted. In yet another embodiment, each of a portion of the exemplary-code and a portion of the code template may be highlighted. As a result, the learner is provided with an indication of the portion of the code template where the learner is required to enter or modify source code.

In an embodiment, each of the learning user-interface and the exemplary-code may be displayed concurrently. For example, a graphical user-interface including the exemplary-code and the learning user-interface in the form of a text input area may be displayed on a display device. In another embodiment, the exemplary-code may be displayed on a first display device and the learning user-interface may be displayed on a second display device. In yet another embodiment, the learning user-interface may be sequentially displayed after displaying the exemplary-code. For example, initially the exemplary-code may be displayed on a display device for a predetermined amount of time. Subsequently, the learning user-interface may be displayed on the display device.

Subsequent to receiving the user-code, in an embodiment, the user-code may be analyzed automatically based on one or more of a syntax corresponding to the programming language and a style guide corresponding to the programming language. In an instance, the user-code entered by the learner may be analysed on a continuous basis as the learner enters each character. In another instance, the user-code entered by the learner may be analysed at the end of a line of the user-code. Accordingly, when the learner enters a Return-key at the end of the line, an analysis of the line may be performed. In another embodiment, the analysis of the user-code may be performed based on an input from the learner. For example, the learning user-interface may include a graphical user-interface element such as a button which may be configured to initiate the analysis of the user-code up on being clicked. In another embodiment, the analysis of the user-code may be performed based on an input from an instructor. In yet another embodiment, the analysis of the user-code may be performed based on a proficiency level of the learner. For example, the proficiency level of the learner may be determined from analysis of user-code entered by the learner in the past. Accordingly, if the proficiency level of the learner is low, the user-code entered by the learner may be analysed. Further, in another embodiment, a portion of the user-code may be analysed. The portion of the user-code may correspond to the concept. Accordingly, in an instance, the analysis of the user-code may be limited to the portion. In another embodiment, the portion of the user-code may be determined based on the proficiency level of the learner. For example, if the learner has demonstrated high proficiency level corresponding to a first portion of the user-code, then the analysis of the user-code may be limited to a second portion of the user-code that may be different from the first portion.

In an embodiment, analysing the user-code based on the syntax may include identifying syntactical errors in the user-code. Such analysis may be performed by a syntax checker. In an embodiment, the analysis of the user-code may be performed by a compiler which includes a functionality of identifying syntactical errors. For example, if the learner entered the user-code including an unbalanced number of opening and closing parenthesis, the analysis of the user-code may identify a syntactical error.

In another embodiment, analysing the user-code based on the style guide may include determining whether characteristics of the user-code conform to guidelines laid down by the style guide. For example, the user-code may be analysed to determine if the number of characters on a line of the user-code are within a predetermined limit prescribed by the style guide.

In another embodiment, the user-code entered by the learner may be transmitted to an instructor. Subsequently, the user-code may be displayed to the instructor on a display device. As a result, the instructor may be able to monitor learning behaviour of the learner. For instance, the instructor may analyse the user-code in order to determine if there are any errors.

In an embodiment, subsequent to analysing the user-code, a feedback may be presented to the learner based on the analysis. The feedback may include information relating to one or more of a syntactical error, a logical error and a suggestion. For example, if the user-code entered by the learner includes a syntactical error such as, for example, a missing delimiter, the feedback in the form of a message may be displayed to the learner. In an instance, the feedback may be presented to the learner through the graphical user-interface including the learning user-interface. Accordingly, the learner may be alerted to the presence of an error in the user-code. As another example, if the user-code entered by the learner includes a logical error such as, for example, a missing exit-condition statement in a loop, the feedback in the form of a message “Infinite loop detected” may be presented to the learner. Similarly, if the user-code entered by the learner is non-optimal, the feedback in the form of the suggestion may be presented to the learner in order to modify the user-code to make it optimal. In other embodiments, the suggestion may include information relating to any aspect that may facilitate learning of the programming language. In an instance, the feedback may be automatically generated by a program such as a compiler. In another instance, the feedback may be generated by the instructor in the form of instructor-feedback. In another embodiment, the feedback may indicate a correctness of a line of the user-code by highlighting the line with a predetermined colour such as “green”. Accordingly, the learner may be assured that the line of the user-code entered is correct. Alternatively, the feedback may indicate an incorrectness of a line of the user-code by highlighting the line with another predetermined colour such as “red”.

In another embodiment, the learner may be provided with an option to request the instructor to review the user-code. Accordingly, when the learner selects the option, the instructor may be presented with a copy of the user-code in real-time. As a result, the instructor may be able to view the user-code entered by the learner and any subsequent insertions and modifications performed by the learner. Additionally, in an embodiment, the instructor may also be provided with an option to make insertions and modifications to the user-code. The insertions and modifications made by the instructor may be reflected in the learning user-interface in an embodiment. Accordingly, the learner may instantly view the changes made by the instructor. Accordingly, based on one or more changes made by one or more of the learner and the instructor, the user-code may be updated. Further, an updated user-code may be presented to one or more of the learner and the instructor. In an embodiment, a real-time chat technology, such as, for example, web-sockets may be used to implement communication of changes to the user-code between the learner and the instructor.

In an embodiment, at step 108, subsequent to receiving the user-code, an exemplary-output based on the exemplary-code may be presented to the learner. In an embodiment, after entering the user-code, the exemplary-output may be automatically presented to the learner. In general, the exemplary-output may be a representation of a result of executing the exemplary-code. Accordingly, in case the exemplary-code is configured for displaying content in a format, the exemplary-output may include a visual representation of the content in the format. For example, consider the exemplary-code to be HTML code for displaying a textual message in a predetermined format. Accordingly, the exemplary-output may be a visual representation of a web page generated according to the HTML code. As another example, consider the exemplary-code to be a Python script for generating a predetermined sound. Accordingly, the exemplary-output may be characteristics of the predetermined sound such as, for example, a time duration, a frequency spectrum and an intensity. The characteristics may be presented in the form of text on a display device. Alternatively, the exemplary-output may be the predetermined sound played on a speaker. As yet another example, consider the exemplary-code to be a C program configured for computing an output value based on a set of input values. Accordingly, the exemplary-output may be a visual representation of the output value presented on a display device.

In an embodiment, the exemplary-output may be generated based on an actual execution of the exemplary-code. Accordingly, the exemplary-code may be executed on a processor. In another embodiment, the exemplary-output may be generated based on a symbolic execution of the exemplary-code. In yet another embodiment, each of the exemplary-code and the exemplary-output may be stored in a database. Accordingly, the exemplary-output may be accessed from the database and subsequently presented to the learner. In another embodiment, the exemplary-output may be based on emulation of an electronic device. For instance, each of the exemplary-code and the learning user-interface may be displayed to the learner on a laptop computer. However, the exemplary-output may correspond to a result of executing the exemplary-code on a smart phone. Therefore, a processor of the laptop computer may be configured for emulating the smart phone. As a result, a display of the exemplary-output on the laptop computer may emulate the look and feel of the smart phone while displaying the exemplary-output.

In an embodiment, at step 110, a user-output based on the user-code may be presented to the learner. In general, the user-output may be a representation of a result of executing the user-code. Accordingly, in case the user-code is configured for displaying content in a format, the user-output may include a visual representation of the content in the format. For example, consider the user-code to be HTML code for displaying a textual message in a predetermined format. Accordingly, the user-output may be a visual representation of a web page generated according to the HTML code.

In an embodiment, each of step 108 and step 110 may be executed concurrently. Accordingly, each of the exemplary-output and the user-output may be concurrently presented to the learner. For example, each of the exemplary-output and the user-output may be displayed concurrently on a display device. In another embodiment, the exemplary-output and the user-output may be displayed alternately on the display device. In yet another embodiment, the exemplary-output and the user-output may be presented to the learner on different devices. In a further embodiment, a modality corresponding to the exemplary-output may be different from a modality corresponding to the user-output. For example, the exemplary-output may be presented on a display device while the user-output may be presented on a speaker. As a result of presenting each of the exemplary-output and the user-output, the learner may be able to realize correctness of the user-code.

In an embodiment, each of the exemplary-output and the user-output may be presented to one or more of the learner, a peer learner and the instructor. The peer learner may be another learner. Accordingly, in an instance, one or more of the peer learner and the instructor may compare the user-output with the exemplary-output and provide a feedback to the learner. Moreover, in an embodiment, the learner may be provided with an option to share one or more of the exemplary-code, the user-code, the exemplary-output and the user-output. Accordingly, the learner may be presented with a user-interface configured for receiving a command. Based on the command, one or more of the exemplary-code, the user-code, the exemplary-output and the user-output may be shared with others. In an embodiment, the sharing may take place over a social network.

In another embodiment, a practicing user-interface including each of a workspace region and a resources region may be displayed to the learner. In general, the practicing user-interface may be configured to enable the learner to practice the concept and corresponding source code embodying the concept. Accordingly, the workspace region may be configured for receiving user-code from the learner. In an embodiment, the workspace region may be configured to receive user-code from more than one learner in order to support collaboration between learners. For instance, a first learner may be given an “author” status and enabled to make changes to the user-code while a second learner may be provided a “viewer” status. Subsequently, the second learner may be given the “author” status to enable the second learner to make changes to the user-code while the first learner is given the “viewer” status. In an instance, the workspace region may be a text input area configured for accepting a textual input and displaying text. Further, the resources region may be configured for providing access to one or more of a toolbox and a code-snippet. In an instance, the toolbox may include one or more tools for facilitating entering of user-code within the workspace region. For example, the toolbox may include for performing one or more of insertion and modification of source code. Accordingly, the toolbox may include GUI elements such as links that are displayed in the resources region. Upon clicking the a link corresponding to a HTML tool of the toolbox, a source code corresponding to the HTML tool such as, for example, a matched pair of “div” tags may be automatically inserted into the workspace region. Further, a resource included in the toolbox such as a tool may be based on the project. Accordingly, depending on the project being created, the learner may be presented with corresponding tools suitable for creating the project. For instance, as the learner progresses in learning the programming language, more tools may be available to the learner in the toolbox. Thus, in some embodiments, the practicing user-interface may function as an integrated development environment for creating source code in the programming language.

The code-snippet included in the resources region may be configured to allow the learner to insert the code-snippet into the workspace region with a single learner input such as a click of a mouse. Further, in another embodiment, the user-code previously entered by the learner may be stored as the code-snippet for subsequent use. In another embodiment, the code-snippet may be based on user-code received through one or more of the learning user-interface and the practicing user-interface. For example, user-code received through the practicing user-interface and successfully validated may be added as the code-snippet in the resources region. In yet another embodiment, a user-code entered by a first learner may be available for use as the code-snippet for a second learner. In some embodiments, hovering a mouse pointer over one or more of a tool of the toolbox and the code-snippet may trigger display of a corresponding tool-tip with a description.

In an instance, the practicing user-interface may be displayed subsequent to successful validation of the user-code entered by the learner in the learning user-interface. Validation of the user-code may be performed by one or more of the learner, a peer learner and the instructor. In another instance, the practicing user-interface may be displayed based on an input from one or more of the learner and the instructor. For example, the learner may be presented with a GUI element such as a link to the practicing user-interface. Upon clicking the link, the learner may be presented with the practicing user-interface.

In some embodiments, the user-code entered by the learner in one or more of the learning user-interface and the practicing user-interface may be hosted on a server. Further, the learner may be provided with an option to share an address link of the server corresponding to the user-code with other users. For instance, the learner may be presented with an option to share the address link with peer learners in the social network of the learner. Accordingly, when a peer learner accesses the address link, the user-code may be executed and the user-output may be presented to the peer learner over a network.

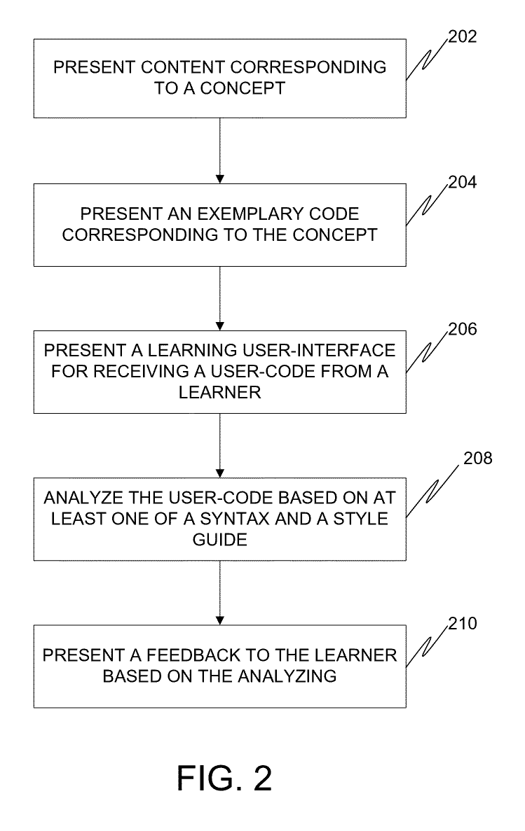

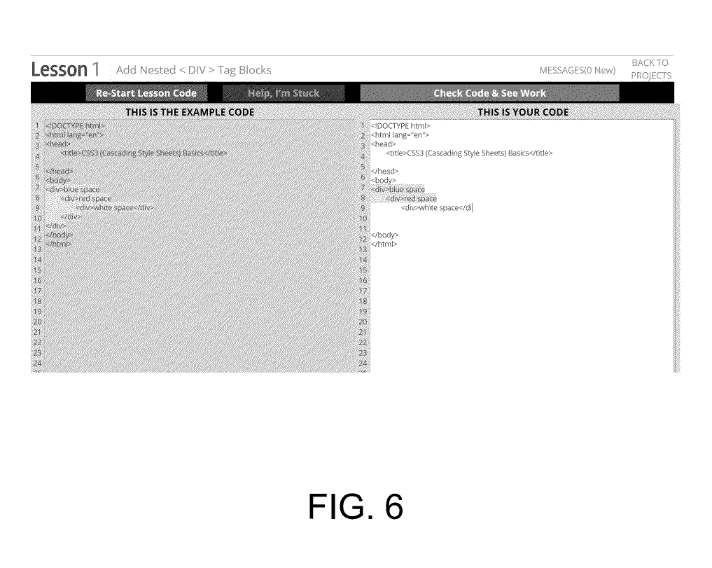

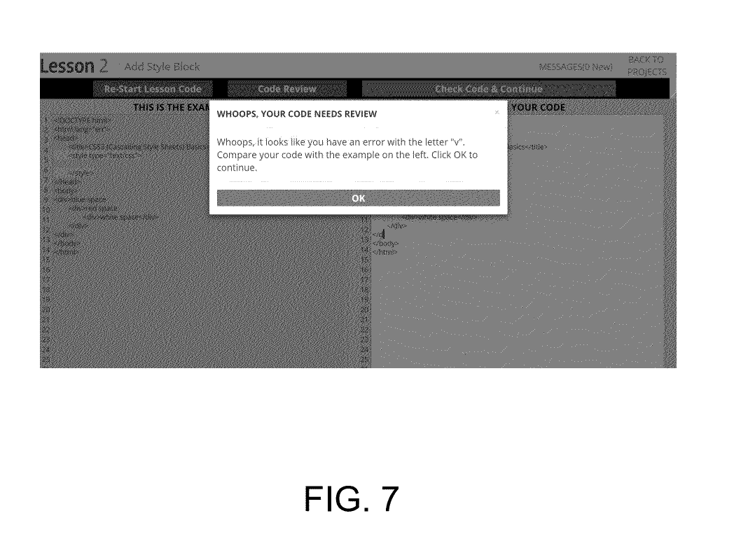

FIG. 2 illustrates a computer implemented method of learning the programming language in accordance with another embodiment. At step 202, content corresponding to the concept may be presented to the learner. The concept may be determined based on one or more of the project, the lesson and the task. Subsequently, the exemplary-code corresponding to the concept may be presented to the learner at step 204. Additionally, at step 206, the learning user-interface configured for receiving the user-code from the learner may be presented. In an embodiment, each of the exemplary-code and the learning user-interface may be displayed concurrently as illustrated in FIG. 6. Subsequent to receiving the user-code, at step 208, the user-code may be analyzed automatically based on one or more of the syntax corresponding to the programming language and the style guide corresponding to the programming language. Accordingly, based on the analysis, the feedback may be presented to the learner as exemplarily illustrated in FIG. 7.

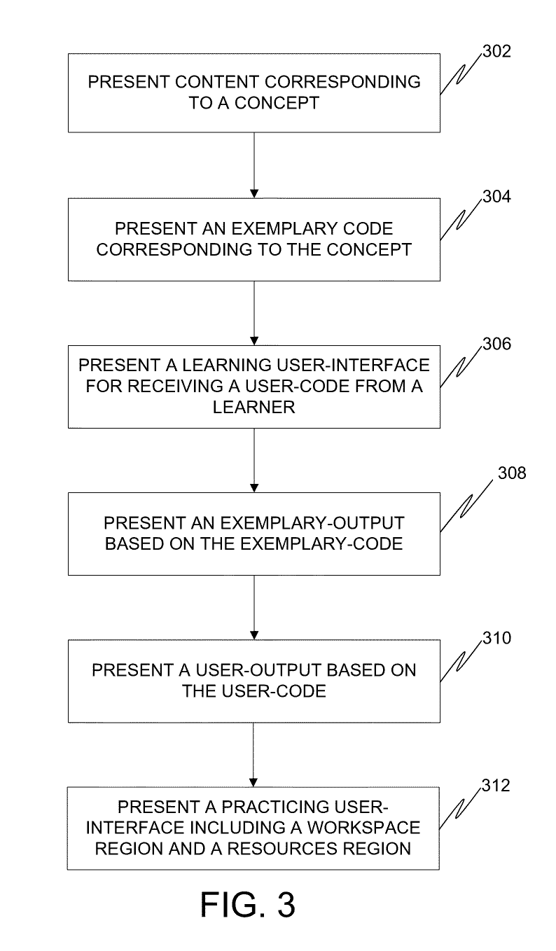

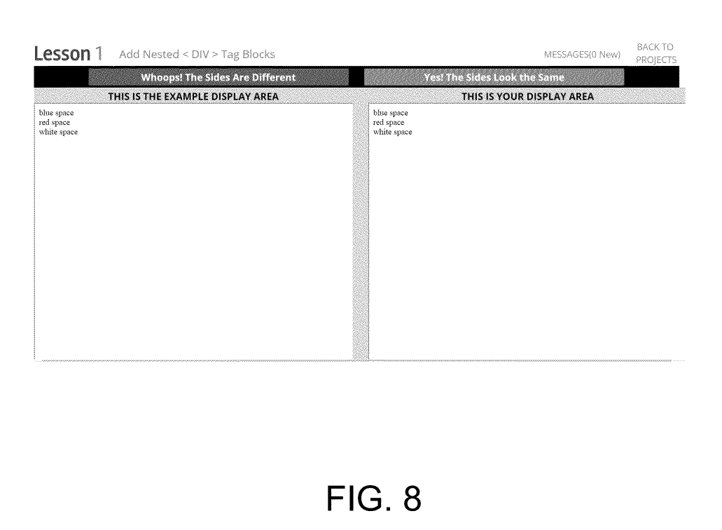

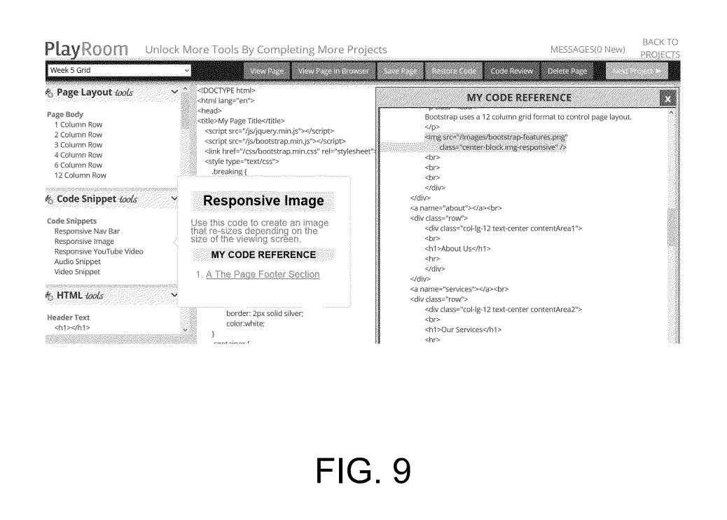

FIG. 3 illustrates a computer implemented method of learning the programming language in accordance with another embodiment. At step 302, content corresponding to the concept may be presented to the learner. The concept may be determined based on one or more of the project, the lesson and the task. Subsequently, the exemplary-code corresponding to the concept may be presented to the learner at step 304. Additionally, at step 306, the learning user-interface configured for receiving the user-code from the learner may be presented. In an embodiment, each of the exemplary-code and the learning user-interface may be displayed concurrently as illustrated in FIG. 6. Subsequently, at step 308, the exemplary-output based on the exemplary-code may be presented to the learner. Further, at step 310, the user-output based on the user-code may be presented to the learner. In an embodiment, each of the exemplary-output and the user-output may be displayed concurrently as illustrated in FIG. 8 in order to enable the learner to make a comparison between the exemplary-output and the user-output. Subsequently, at step 312, the practicing user-interface may be presented to the learner as exemplarily illustrated in FIG. 9.

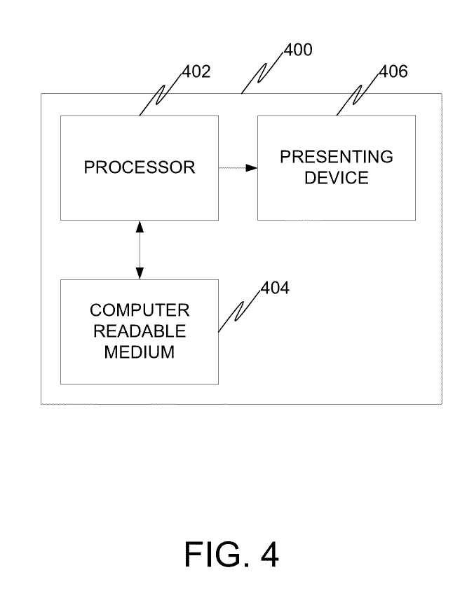

FIG. 4 illustrates a system 400 for facilitating learning of the programming language. The system 400 includes a processor 402 configured for executing program instructions and a computer readable medium 404 configured for storing the program instructions. The system 400 further includes a presenting device, such as for example, a display device. Upon executing the program instructions by the processor, content corresponding to the concept may be presented on the presenting device. In an embodiment, presenting content corresponding to the concept may include displaying the virtual flashcard. Subsequently, the exemplary-code corresponding to the concept may also be presented. The exemplary-code may be based on the programming language. Additionally, the learning user-interface configured for receiving the user-code from the learner may be presented. In an embodiment, the learning user-interface may include the code-template. Further, the portion of the code-template corresponding to the user-code may be highlighted. Additionally, in another embodiment, the computer readable medium 404 may be configured for storing additional program instructions configured for receiving the instructor-feedback based on the user-code. The instructor-feedback may be provided by the instructor. Subsequently, the instructor-feedback may be presented to the learner.

Thereafter, the exemplary-output based on the exemplary-code may be presented. The exemplary-output may be a representation of the result of executing the exemplary-code. In an embodiment, executing the exemplary-code may be based on emulation of the electronic device. Further, the user-output based on the user-code may also be presented to the learner. The user-output may be a representation of the result of executing the user-code. In an embodiment, executing the user-code may be based on one or more of symbolic execution and actual execution.

In an embodiment, presenting the exemplary-output may be performed concurrent with presenting the user-output.

In an embodiment, the computer readable medium 404 may be configured for storing additional program instructions configured for performing analysis of the user-code based on one or more of the syntax corresponding to the programming language and the style guide corresponding to the programming language. Further, the additional program instructions may be configured for presenting the feedback to the learner based on the analysis. In an embodiment, the feedback may include one or more of the syntactical error, the logical error and the suggestion. In an embodiment, upon validation of the user-code, the system 400 may be further configured for hosting the user-code on the server.

In another embodiment, the computer readable medium 404 may be configured for storing additional program instructions configured for displaying the practicing user-interface including each of the workspace region and the resources region. The workspace region may be configured for receiving user-code from one or more learners. Further, the resources region may be configured for providing access to one or more of the toolbox and the code-snippet. In an embodiment, the code-snippet may be based on user-code received through one or more of the learning user-interface and the practicing user-interface. In an embodiment, the resource included in the toolbox may be based on the project being created by the learner.

Further, in an embodiment, the practicing user-interface may be configured for copying the code-snippet into the workspace region based on the single learner input received from the learner. In another embodiment, the practicing user-interface may be configured for receiving a command from the learner. Further, the system 400 may be configured for sharing one or more of the user-code, the user-output, the exemplary-code and the exemplary-output based on the command.

The described techniques may be implemented as a method, apparatus or article of manufacture involving software, firmware, micro-code, hardware and/or any combination thereof. The term “article of manufacture” as used herein refers to code or logic implemented in a medium, where such medium may comprise hardware logic [e.g., an integrated circuit chip, Programmable Gate Array (PGA), Application Specific Integrated Circuit (ASIC), etc.] or a computer readable medium, such as magnetic storage medium (e.g., hard disk drives, floppy disks, tape, etc.), optical storage (CD-ROMs, optical disks, etc.), volatile and non-volatile memory devices [e.g., Electrically Erasable Programmable Read Only Memory (EEPROM), Read Only Memory (ROM), Programmable Read Only Memory (PROM), Random Access Memory (RAM), Dynamic Random Access Memory (DRAM), Static Random Access Memory (SRAM), flash, firmware, programmable logic, etc.]. Code in the computer readable medium is accessed and executed by a processor. The medium in which the code or logic is encoded may also comprise transmission signals propagating through space or a transmission media, such as an optical fiber, copper wire, etc. The transmission signal in which the code or logic is encoded may further comprise a wireless signal, satellite transmission, radio waves, infrared signals, Bluetooth, etc. The transmission signal in which the code or logic is encoded is capable of being transmitted by a transmitting station and received by a receiving station, where the code or logic encoded in the transmission signal may be decoded and stored in hardware or a computer readable medium at the receiving and transmitting stations or devices. Additionally, the “article of manufacture” may comprise a combination of hardware and software components in which the code is embodied, processed, and executed. Of course, those skilled in the art will recognize that many modifications may be made without departing from the scope of embodiments, and that the article of manufacture may comprise any information bearing medium. For example, the article of manufacture comprises a storage medium having stored therein instructions that when executed by a machine results in operations being performed. Certain embodiments can take the form of an entirely hardware embodiment, an entirely software embodiment or an embodiment containing both hardware and software elements. In an embodiment, the invention may be implemented in software, which includes but is not limited to firmware, resident software, microcode, etc.

Furthermore, certain embodiments can take the form of a computer program product accessible from a computer usable or computer readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

The terms “certain embodiments”, “an embodiment”, “embodiment”, “embodiments”, “the embodiment”, “the embodiments”, “one or more embodiments”, “some embodiments”, and “one embodiment” mean one or more (but not all) embodiments unless expressly specified otherwise. The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries. Additionally, a description of an embodiment with several components in communication with each other does not imply that all such components are required. On the contrary a variety of optional components are described to illustrate the wide variety of possible embodiments.

Furthermore, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously, in parallel, or concurrently.

When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article. The functionality and/or the features of a device may be alternatively embodied by one or more other devices which are not explicitly described as having such functionality/features. Thus, other embodiments need not include the device itself.

Computer program means or computer program in the present context mean any expression, in any language, code or notation, of a set of instructions intended to cause a system having an information processing capability to perform a particular function either directly or after either or both of the following a) conversion to another language, code or notation; b) reproduction in a different material form.

The above-disclosed subject matter is to be considered illustrative, and not restrictive, and the appended claims are intended to cover all such modifications, enhancements, and other embodiments that fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

While the present invention has been described in the foregoing embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadcast interpretation so as to encompass all such modifications and equivalent structures and functions.

We claim:

1. A computer implemented method of facilitating learning of a programming language, the method comprising:
a. presenting content corresponding to at least one concept;
b. presenting an exemplary-code corresponding to the at least one concept, wherein the exemplary-code is based on the programming language;
c. presenting a learning user-interface configured for receiving a user-code from at least one learner;
d. presenting at least one exemplary-output based on the exemplary-code, wherein the at least one exemplary-output is a representation of a result of executing the exemplary-code; and
e. presenting at least one user-output based on the user-code, wherein the at least one user-output is a representation of a result of executing the user-code.

2. The computer implemented method of claim 1 further comprising:
a. analyzing the user-code based on at least one of a syntax corresponding to the programming language and a style guide corresponding to the programming language; and
b. presenting a feedback to the at least one learner based on the analyzing.

3. The computer implemented method of claim 2, wherein the feedback comprises at least one of a syntactical error, a logical error and a suggestion.

4. The computer implemented method of claim 1, wherein presenting content corresponding to the at least one concept comprises displaying at least one virtual flashcard.

5. The computer implemented method of claim 1, wherein the learning user-interface comprises a code-template, wherein the computer implemented method further comprises highlighting a portion of the code-template corresponding to the user-code.

6. The computer implemented method of claim 1, wherein executing the user-code is based on at least one of symbolic execution and actual execution.

7. The computer implemented method of claim 1, wherein presenting the at least one exemplary-output is concurrent with presenting the at least one user-output.

8. The computer implemented method of claim 1 further comprising displaying a practicing user-interface comprising each of a workspace region and a resources region, wherein the workspace region is configured for receiving user-code from the at least one user, wherein the resources region is configured for providing access to at least one of a toolbox and a code-snippet.

9. The computer implemented method of claim 8, wherein the code-snippet is based on user-code received through at least one of the learning user-interface and the practicing user-interface.

10. The computer implemented method of claim 1, wherein the at least one concept corresponds to a project comprising at least one lesson, wherein the at least one lesson comprises at least one task, wherein at least one of the at least one lesson and the at least one task are ordered in a sequence, wherein the at least one concept is identified based on the at least one task and the sequence.

11. The computer implemented method of claim 1 further comprising:
a. receiving instructor-feedback based on the user-code, wherein the instructor-feedback is provided by an instructor; and
b. presenting the instructor-feedback to the at least one learner.

12. The computer method of claim 1, wherein executing the exemplary-code is based on emulation of at least one electronic device.

13. The computer method of claim 8, wherein the practicing user-interface is further configured for receiving a command from the at least one user, wherein the computer implemented method further comprises sharing at least one of the user-code, the at least one user-output, the exemplary-code and the at least one exemplary-output based on the command.

14. The computer implemented method of claim 8, wherein the at least one concept corresponds to a project, wherein at least one resource comprised in the toolbox is based on the project.

15. The computer implemented method of claim 8, wherein the practicing user-interface is further configured for copying the code-snippet into the workspace region based on a single learner input received from the at least one user.

16. The computer implemented method of claim 1 further comprising hosting the user-code on a server.

17. The computer implemented method of claim 1 further comprising:
a. presenting at least one of the exemplary-code and the user-code to an instructor;
b. receiving at least one change to the user-code from at least one of the learner and the instructor; and
c. presenting an updated user-code to at least one of the user and the instructor based on the at least one change.

18. A system for facilitating learning of a programming language, the system comprising a processor and a computer readable medium configured for storing program instructions, wherein executing the program instructions by the processor causes:
a. presenting content corresponding to at least one concept;
b. presenting an exemplary-code corresponding to the at least one concept, wherein the exemplary-code is based on the programming language;
c. presenting a learning user-interface configured for receiving a user-code from at least one learner;
d. presenting at least one exemplary-output based on the exemplary-code, wherein the at least one exemplary-output is a representation of a result of executing the exemplary-code; and
e. presenting at least one user-output based on the user-code, wherein the at least one user-output is a representation of a result of executing the user-code.

19. The system of claim 18, wherein the computer readable medium is configured for storing additional program instructions, wherein executing the additional program instructions by the processor causes:
a. analyzing the user-code based on at least one of a syntax corresponding to the programming language and a style guide corresponding to the programming language; and
b. presenting a feedback to the at least one learner based on the analyzing.

20. The system of claim 19, wherein the feedback comprises at least one of a syntactical error, a logical error and a suggestion.

21. The system of claim 18, wherein presenting content corresponding to the at least one concept comprises displaying at least one virtual flashcard.

22. The system of claim 18, wherein the learning user-interface comprises a code-template, wherein the system further comprises highlighting a portion of the code-template corresponding to the user-code.

23. The system of claim 18, wherein executing the user-code is based on at least one of symbolic execution and actual execution.

24. The system of claim 18, wherein presenting the at least one exemplary-output is concurrent with presenting the at least one user-output.

25. The system of claim 18, wherein the computer readable medium is configured for storing additional program instructions, wherein executing the additional program instructions by the processor causes displaying a practicing user-interface comprising each of a workspace region and a resources region, wherein the workspace region is configured for receiving user-code from the at least one user, wherein the resources region is configured for providing access to at least one of a toolbox and a code-snippet.

26. The system of claim 25, wherein the code-snippet is based on user-code received through at least one of the learning user-interface and the practicing user-interface.

27. The system of claim 18, wherein the at least one concept corresponds to a project comprising at least one lesson, wherein the at least one lesson comprises at least one task, wherein at least one of the at least one lesson and the at least one task are ordered in a sequence, wherein the at least one concept is identified based on the at least one task and the sequence.

28. The system of claim 18, wherein the computer readable medium is configured for storing additional program instructions, wherein executing the additional program instructions by the processor causes:
a. receiving instructor-feedback based on the user-code, wherein the instructor-feedback is provided by an instructor; and
b. presenting the instructor-feedback to the at least one user.

29. The system of claim 18, wherein executing the exemplary-code is based on emulation of at least one electronic device.

30. The system of claim 25, wherein the practicing user-interface is configured for receiving a command from the at least one user, wherein the system is configured for sharing at least one of the user-code, the at least one user-output, the exemplary-code and the at least one exemplary-output based on the command.

31. The system of claim 25, wherein the at least one concept corresponds to a project, wherein at least one resource comprised in the toolbox is based on the project.

32. The system of claim 25, wherein the practicing user-interface is further configured for copying the code-snippet into the workspace region based on a single learner input received from the at least one user.

33. The system of claim 18 further configured for hosting the user-code on a server.
